(19) United States
(12) Patent Application Publication
(10) Pub. No.: US 2026/0247372 A1
(43) Pub. Date: Aug. 20, 2026

(54) CONTROL INFORMATION TRANSMISSION FOR UNSCHEDULED CARRIERS IN WIRELESS COMMUNICATIONS

(71) Applicant: QUALCOMM Incorporated, San Diego, CA (US)

(72) Inventors: Diana MAAMARI, San Diego, CA (US); Gabi SARKIS, San Diego, CA (US); Kianoush HOSSEINI, San Diego, CA (US); Mostafa KHOSHNEVISAN, San Diego, CA (US)

(21) Appl. No.: 19/054,611

(22) Filed: Feb. 14, 2025

(51) Int. Cl. H04W 72/1268; H04W 72/232

(52) U.S. Cl. CPC H04W 72/1268; H04W 72/232

(57) ABSTRACT

Methods, systems, and devices for wireless communications are described for adjustment of a size of downlink control information (DCI) that schedules two or more carriers. A user equipment (UE) may receive first control information that activates a set of carriers and that indicates a scheduling DCI configuration with a first scheduling DCI size. The UE may receive second control information that indicates a first subset of the set of carriers are schedulable for communications, and one or more carriers will be unscheduled for communications during a time period. Based on the first and second control information, the UE may monitor for scheduling information in a DCI monitoring occasion. The scheduling information may have the first scheduling DCI size or a second scheduling DCI size based on a time duration between receipt of the second control information and a start of the DCI monitoring occasion.

### FIELD OF TECHNOLOGY

The following relates to wireless communications, including control information transmission for unscheduled carriers in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, receiving second control information that indicates a first subset of the set of carriers are schedulable for communications during at least a first time period and one or more carriers of the set of carriers will be unscheduled for communications during at least the first time period, and monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

A UE for wireless communications is described. The UE may include one or more memories storing processor executable code, and one or more processors coupled with the one or more memories. The one or more processors may individually or collectively be operable to execute the code to cause the UE to receive first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, receive second control information that indicates a first subset of the set of carriers are schedulable for communications during at least a first time period and one or more carriers of the set of carriers will be unscheduled for communications during at least the first time period, and monitor for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

Another UE for wireless communications is described. The UE may include means for receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, means for receiving second control information that indicates a first subset of the set of carriers are schedulable for communications during at least a first time period and one or more carriers of the set of carriers will be unscheduled for communications during at least the first time period, and means for monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

A non-transitory computer-readable medium storing code for wireless communications is described. The code may include instructions executable by one or more processors to receive first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, receive second control information that indicates a first subset of the set of carriers are schedulable for communications during at least a first time period and one or more carriers of the set of carriers will be unscheduled for communications during at least the first time period, and monitor for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

In some examples of the method, UEs, and non-transitory computer-readable medium described herein, the scheduling information in the downlink control information monitoring occasion has the first scheduling information size when the time duration between receipt of the second control information and the start of the downlink control information monitoring occasion is less than a first time threshold value. In some examples of the method, UEs, and non-transitory computer-readable medium described herein, the monitoring may include operations, features, means, or instructions for receiving the scheduling information in the downlink control information monitoring occasion and ignoring one or more fields of the scheduling information that are associated with the one or more carriers that are unscheduled for communications. In some examples of the method, UEs, and non-transitory computer-readable medium described herein, the monitoring may include operations, features, means, or instructions for receiving the scheduling information in the downlink control information monitoring occasion in a first subset of fields associated with the first subset of the set of carriers and in a second subset of fields associated with the one or more carriers that are unscheduled for communications, where the second subset of fields include additional information associated with the first subset of carriers.

In some examples of the method, UEs, and non-transitory computer-readable medium described herein, the scheduling information in the downlink control information monitoring occasion has the second scheduling information size when the time duration between receipt of the second control information and the start of the downlink control information monitoring occasion exceeds a second time threshold value, and where the second scheduling information size is based on one or more fields associated with the first carrier being omitted from the scheduling information.

Some examples of the method, UEs, and non-transitory computer-readable medium described herein may further include operations, features, means, or instructions for transmitting an indication of one or more timelines that are supported at the UE for switching the first scheduling information size to the second scheduling information size.

In some examples of the method, UEs, and non-transitory computer-readable medium described herein, the scheduling information in the downlink control information monitoring occasion has the second scheduling information size when the time duration between receipt of the second control information and the start of the downlink control information monitoring occasion exceeds a third time threshold value, and where the second scheduling information size is associated with one or more combinations of carriers of the first subset of the set of carriers.

In some examples of the method, UEs, and non-transitory computer-readable medium described herein, the second scheduling information size is based on a first combination of two or more combinations of carriers of the subset of carriers that can be scheduled during the first time period, the first combination associated with a largest payload size of two or more payload sizes associated with the two or more combinations of carriers of the subset of carriers.

In some examples of the method, UEs, and non-transitory computer-readable medium described herein, the second control information includes a table that provides a mapping between a codepoint that is provided in the scheduling information and one or more scheduled carriers of the subset of carriers.

In some examples of the method, UEs, and non-transitory computer-readable medium described herein, the second scheduling information size is based on a first subset of fields associated with the first subset of the set of carriers. In some examples of the method, UEs, and non-transitory computer-readable medium described herein, the second scheduling information size corresponds to a payload size associated with the first combination of the two or more combinations of carriers of the subset of carriers that can be scheduled during the first time period.

In some examples of the method, UEs, and non-transitory computer-readable medium described herein, the scheduling information does not include frequency domain resource assignment fields when the time duration between receipt of the second control information and the start of the downlink control information monitoring occasion exceeds a time threshold value.

In some examples of the method, UEs, and non-transitory computer-readable medium described herein, the scheduling information includes frequency domain resource assignment fields when the time duration between receipt of the second control information and the start of the downlink control information monitoring occasion is less than a time threshold value, and where one or more frequency domain resource assignment fields associated with the first carrier is set to a predetermined value.

In some examples of the method, UEs, and non-transitory computer-readable medium described herein, the time duration between receipt of the second control information and the start of the downlink control information monitoring occasion that indicates the first scheduling information size or the second scheduling information size is based on a capability reported by the UE or a mode of operation indicated by a network entity.

In some examples of the method, UEs, and non-transitory computer-readable medium described herein, the monitoring may include operations, features, means, or instructions for attempting to decode the scheduling information from two or more sets of candidate control channel elements, where a quantity of sets of candidate control channel elements are based on the second control information.

In some examples of the method, UEs, and non-transitory computer-readable medium described herein, a downlink control channel blind decoding budget may be determined in accordance with the set of carriers irrespective of whether one or more carriers is indicated to be unscheduled for communications during at least the first time period.

A method for wireless communications by a network entity is described. The method may include outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, outputting second control information that indicates a first subset of the set of carriers are schedulable for communications during at least a first time period and one or more carriers of the set of carriers will be unscheduled for communications during at least the first time period, and outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

A network entity for wireless communications is described. The network entity may include one or more memories storing processor executable code, and one or more processors coupled with the one or more memories. The one or more processors may individually or collectively be operable to execute the code to cause the network entity to output first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, output second control information that indicates a first subset of the set of carriers are schedulable for communications during at least a first time period and one or more carriers of the set of carriers will be unscheduled for communications during at least the first time period, and output scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

Another network entity for wireless communications is described. The network entity may include means for outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, means for outputting second control information that indicates a first subset of the set of carriers are schedulable for communications during at least a first time period and one or more carriers of the set of carriers will be unscheduled for communications during at least the first time period, and means for outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

A non-transitory computer-readable medium storing code for wireless communications is described. The code may include instructions executable by one or more processors to output first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message, output second control information that indicates a first subset of the set of carriers are schedulable for communications during at least a first time period and one or more carriers of the set of carriers will be unscheduled for communications during at least the first time period, and output scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

In some examples of the method, network entities, and non-transitory computer-readable medium described herein, the scheduling information in the downlink control information monitoring occasion has the first scheduling information size when the time duration between the second control information and the start of the downlink control information monitoring occasion is less than a first time threshold value.

In some examples of the method, network entities, and non-transitory computer-readable medium described herein, one or more fields of the scheduling information that are associated with the one or more carriers that are unscheduled for communications are ignored.

In some examples of the method, network entities, and non-transitory computer-readable medium described herein, the scheduling information in the downlink control information monitoring occasion includes a first subset of fields associated with the first subset of the set of carriers and a second subset of fields associated with the one or more carriers that are unscheduled for communications, where the second subset of fields include additional information associated with the first subset of carriers.

In some examples of the method, network entities, and non-transitory computer-readable medium described herein, the scheduling information in the downlink control information monitoring occasion has the second scheduling information size when the time duration between the second control information and the start of the downlink control information monitoring occasion exceeds a second time threshold value, and where the second scheduling information size is based on one or more fields associated with the first carrier being omitted from the scheduling information.

Some examples of the method, network entities, and non-transitory computer-readable medium described herein may further include operations, features, means, or instructions for obtaining an indication of one or more timelines that are supported at the UE for switching the first scheduling information size to the second scheduling information size.

In some examples of the method, network entities, and non-transitory computer-readable medium described herein, the scheduling information in the downlink control information monitoring occasion has the second scheduling information size when the time duration between receipt of the second control information and the start of the downlink control information monitoring occasion exceeds a third time threshold value, and where the second scheduling information size is associated with one or more combinations of carriers of the first subset of the set of carriers.

In some examples of the method, network entities, and non-transitory computer-readable medium described herein, the second scheduling information size is based on a first combination of two or more combinations of carriers of the subset of carriers that can be scheduled during the first time period, the first combination associated with a largest payload size of two or more payload sizes associated with the two or more combinations of carriers of the subset of carriers.

In some examples of the method, network entities, and non-transitory computer-readable medium described herein, the second control information includes a table that provides a mapping between a codepoint that is provided in the scheduling information and one or more scheduled carriers of the subset of carriers.

In some examples of the method, network entities, and non-transitory computer-readable medium described herein, the second scheduling information size is based on a first subset of fields associated with the first subset of the set of carriers.

In some examples of the method, network entities, and non-transitory computer-readable medium described herein, the second scheduling information size corresponds to a payload size associated with the first combination of the two or more combinations of carriers of the subset of carriers that can be scheduled during the first time period.

In some examples of the method, network entities, and non-transitory computer-readable medium described herein, the scheduling information does not include frequency domain resource assignment fields when the time duration between the second control information and the start of the downlink control information monitoring occasion exceeds a time threshold value.

In some examples of the method, network entities, and non-transitory computer-readable medium described herein, the scheduling information includes frequency domain resource assignment fields when the time duration between the second control information and the start of the downlink control information monitoring occasion is less than a time threshold value, and where one or more frequency domain resource assignment fields associated with the first carrier are set to a predetermined value.

In some examples of the method, network entities, and non-transitory computer-readable medium described herein, the time duration between the second control information and the start of the downlink control information monitoring occasion that indicates the first scheduling information size or the second scheduling information size is based on a capability reported by the UE or a mode of operation indicated by the network entity.

In some examples of the method, network entities, and non-transitory computer-readable medium described herein, the downlink control information is provided in a set of control channel elements of two or more sets of candidate control channel elements, and a quantity of sets of candidate control channel elements is based on the second control information.

In some examples of the method, network entities, and non-transitory computer-readable medium described herein, a downlink control channel blind decoding budget at the UE is determined in accordance with the set of carriers irrespective of whether one or more carriers are indicated to be unscheduled for communications during at least the first time period.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports in accordance with one or more aspects of the present disclosure.

FIG. 2 shows an example of a wireless communications system that supports in accordance with one or more aspects of the present disclosure.

FIG. 3 shows an example of a control information configuration that supports control information transmission for unscheduled carriers in wireless communications in accordance with one or more aspects of the present disclosure.

FIG. 4 shows an example of a process flow that supports control information transmission for unscheduled carriers in wireless communications in accordance with one or more aspects of the present disclosure.

FIGS. 5 and 6 show block diagrams of devices that support control information transmission for unscheduled carriers in wireless communications in accordance with one or more aspects of the present disclosure.

FIG. 7 shows a block diagram of a communications manager that supports in accordance with one or more aspects of the present disclosure.

FIG. 8 shows a diagram of a system including a device that supports control information transmission for unscheduled carriers in wireless communications in accordance with one or more aspects of the present disclosure.

FIGS. 9 and 10 show block diagrams of devices that support control information transmission for unscheduled carriers in wireless communications in accordance with one or more aspects of the present disclosure.

FIG. 11 shows a block diagram of a communications manager that supports in accordance with one or more aspects of the present disclosure.

FIG. 12 shows a diagram of a system including a device that supports control information transmission for unscheduled carriers in wireless communications in accordance with one or more aspects of the present disclosure.

FIGS. 13 and 14 show flowcharts illustrating methods that support control information transmission for unscheduled carriers in wireless communications in accordance with one or more aspects of the present disclosure.

### DETAILED DESCRIPTION

Wireless networks may schedule user equipment (UE) for wideband communications where the UE operates at its higher power level in order to receive the communications via the wide bandwidth. The high-power state includes the UE using a higher clock frequency and generally a higher supply voltage, which may lead to an increase in power consumption by the UE. In such cases, the increase in power consumption may be non-linear (e.g., quadratic) as bandwidth increases. In some examples, the wideband communications may be scheduled in an efficient manner where the UE is scheduled for the wideband communications during a first time period (e.g., a first slot or set of slots) and then the UE is not scheduled for the wideband communications during a second time period (e.g., the next few slot(s)). For example, a UE may have two or more active component carriers (CCs) where a first CC may be a narrowband carrier (e.g., a carrier that occupies a 20 MHz channel bandwidth) and a second CC may be a wideband carrier (e.g., a carrier that occupies 100 MHz channel bandwidth) or a narrowband carrier. In some cases, a UE may be scheduled on the second CC for a first slot or first set of slots, and it may be indicated that a second set of slots will not be scheduled even though the second CC remains an active CC. In such cases, the UE may switch to a lower power level during the second set of slots, such as by reducing a clock frequency and supply voltage based on more relaxed processing timelines that are associated with the narrowband first CC. Such techniques may allow for substantial power reductions at a UE.

It may be desirable to further enhance wireless network efficiency when such techniques are used. For example, downlink control information (DCI) may be used to provide scheduling information to a UE, and a DCI that provides such information may be referred to as a scheduling DCI. A scheduling DCI that provides scheduling information for multiple CCs may include information associated with each of the CCs, and a size of a scheduling DCI may be dependent upon a quantity of CCs, a bandwidth of each CC, or any combination thereof. As discussed herein, in some aspects it may be indicated that one or more CCs will not be scheduled for a particular time period. In accordance with various aspects, a size of a scheduling DCI in cases where one or more CCs are indicated to not be scheduled may be adjusted.

In some aspects, a UE may receive first control information that activates a set of carriers and that indicates a scheduling information configuration (e.g., a scheduling DCI configuration) associated with the set of carriers that indicates a first scheduling information size. The UE may receive second control information that indicates a first subset of the set of carriers are schedulable for communications, and one or more carriers will be unscheduled for communications during a time period. Based on the first and second control information, the UE may monitor for scheduling information in a DCI monitoring occasion. The scheduling information may have the first scheduling information size or a second scheduling information size based on a time duration between receipt of the second control information and a start of the DCI monitoring occasion. In some aspects, if the second scheduling information is not received with sufficient time (e.g., by a time T1) from its application, then a subsequent scheduling DCI may still include the relevant fields for the unschedulable carrier(s), but the UE may either ignore these fields, or these fields may be repurposed to provide finer granularity of valid fields for the active scheduled carrier(s). In other aspects, the second scheduling information may be received with sufficient time (e.g., by a time T2) from its application to adjust an expected size of a scheduling DCI, and the scheduling DCI may not include fields for the unschedulable carriers. In some aspects, the timeline T2 may be a timeline sufficient to retune radio frequency (RF) components, reconfigure baseband (BB) processing, and reconfigure DCI size. In some further aspects, the second scheduling information may be received with sufficient time (e.g., by a time T3) from its application to optimize a size of a scheduling DCI to correspond to one or more combinations of schedulable carriers. Additionally, or alternatively, a quantity of blind decodes (BDs) or control channel elements (CCEs) used for a scheduling DCI may be adapted based on the indication that one or more carriers will be unscheduled. In some aspects, irrespective of whether a carrier is indicated to not be scheduled, the carrier may be counted toward physical downlink control channel (PDCCH) BD resource budgeting at the UE.

A UE operating in accordance with techniques as discussed herein may thus operate with reduced power consumption associated with narrow bandwidth communications, and also a scheduling DCI may be received in accordance with a DCI size that may be based on a timing of an indication that one or more carriers will be unscheduled. Such techniques may enhance UE operation by reducing power consumption and processing resource usage. Further, such techniques provide for reduced overhead associated with scheduling DCIs through DCI size adjustment based on carriers that are schedulable at the UE.

Aspects of the disclosure are initially described in the context of wireless communications systems. Aspects of the disclosure are further illustrated by and described with reference to control information configuration, process flows, apparatus diagrams, system diagrams, and flowcharts that relate to control information transmission for unscheduled carriers in wireless communications.

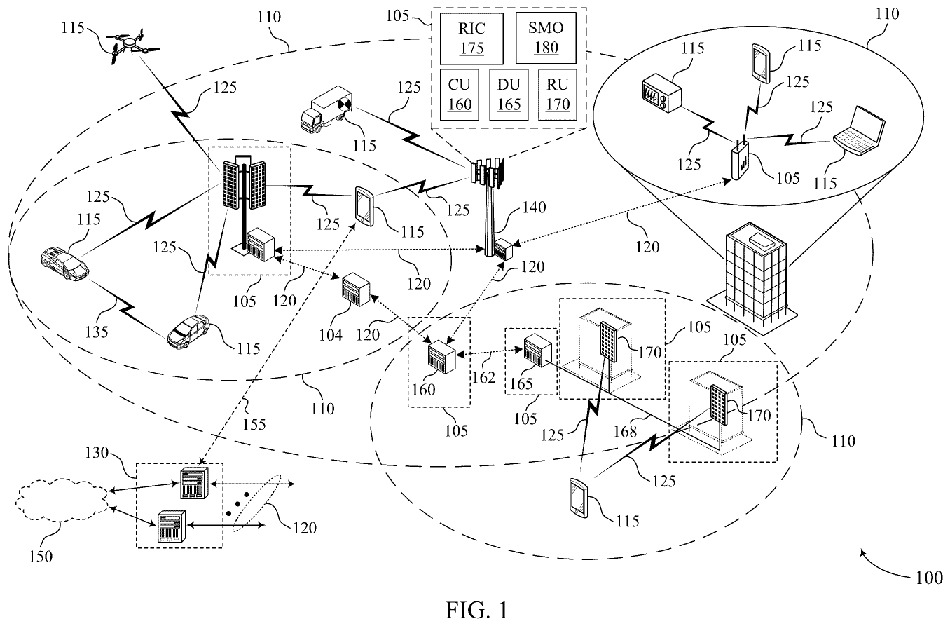

FIG. 1 shows an example of a wireless communications system 100 that supports control information transmission for unscheduled carriers in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support control information transmission for unscheduled carriers in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, a UE 115 may receive first control information that activates a set of carriers and that indicates a scheduling information configuration (e.g., a scheduling DCI configuration) associated with the set of carriers that indicates a first scheduling DCI size. The UE 115 may receive second control information that indicates a first subset of the set of carriers are schedulable for communications, and one or more carriers will be unscheduled for communications during a time period. Based on the first and second control information, the UE 115 may monitor for scheduling information in a DCI monitoring occasion. The scheduling information may have the first scheduling information size or a second scheduling information size based on a time duration between receipt of the second control information and a start of the DCI monitoring occasion.

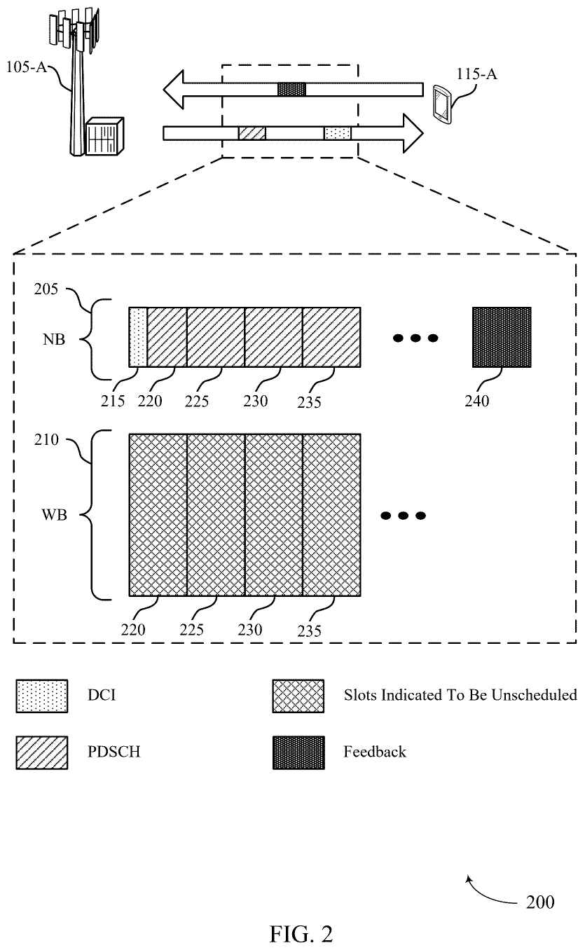

FIG. 2 shows an example of a wireless communications system 200 that supports control information transmission for unscheduled carriers in wireless communications in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described herein.

In some examples, the UE 115-a may be configured to perform RF operations, baseband operations, or both. For high throughput and wideband scheduling, the UE 115-a may enter its highest power state. In new radio (NR) wireless communications systems, the UE 115-a may move its internal baseband clock/voltage to higher power state when the UE 115-a switches to wideband scheduling. This high-power mode of the UE 115-a involves higher clock frequency and generally higher supply voltage to support the higher clock frequency, leading to a quadratic increase in power consumption as well as leakage.

In some cases, a network entity 105-a may inform the UE 115-a as to how long the UE 115-a will be scheduled with wideband scheduling, or multi-CC scheduling, such that the UE 115 may set its clock frequency and voltage as needed and not necessitate the highest setting corresponding to the wideband scheduling or multi-CC scheduling for longer than is needed. The UE 115-a may benefit from an indication that the UE 115-a will not be scheduled with sustained peak throughput. For example, the network entity 105-a may guarantee the UE 115-a that there will be no scheduling of PDSCH transmissions following a wideband scheduling, or that one or more CCs will remain unscheduled for a period of time.

In some cases, the network entity 105-a may guarantee (e.g., signal) to the UE 115-a that: a maximum scheduled throughput may not exceed a limit; feedback timeline may be relaxed; if feedback occasion is kept the same as with narrowband scheduling, the broadband may be kept at low; there will be gaps (e.g., scheduling gaps) between PDSCH transmissions, or one or more CCs (e.g., a wideband CC) will not be scheduled for a particular time period (e.g., a first time period, which may correspond to an indicated time, a number of slots, etc.).

In some examples, the UE 115-a may be configured for efficient downlink scheduling. PDSCH scheduling may be wideband but peak throughput may be reduced for the wideband scheduling by specifying that certain carriers or slots may not be scheduled, by specifying a relaxation in the feedback timeline, or both. For example, one or more predefined communication parameters or rules may indicate that the UE 115-a will not be scheduled with any PDSCH transmission in one or more carriers. In an efficient scheduling mode, the UE 115-a may perform decoupling of RF and baseband power state, which may enable reduction in UE energy. For example, the network entity 105-a may configure the UE 115-a with multiple CCs, including a narrowband CC 205 (e.g., a carrier that occupies a 20 MHz channel bandwidth) and a wideband CC 210 (e.g., a carrier that occupies a 100 MHz channel bandwidth). While a wideband CC 210 is shown in this example, techniques as discussed herein may also apply to cases where multiple narrowband CCs are configured, or any combination of wideband and narrowband CCs are configured. In the example of FIG. 2, both the narrowband CC 205 and the wideband CC 210 may be scheduled in a first slot 220, and only the narrowband CC 205 may be scheduled in a second slot 225, third slot 230, and fourth slot 235. In some cases, the UE 115-a may receive information subsequent to being configured with the multiple CCs that indicates that one or more slots are to be unscheduled for the wideband CC 210 (e.g., in RRC signaling, in a MAC control element (MAC-CE), or in downlink control information (DCI)). Based on this indication, the UE 115-a may skip monitoring the slots indicated to be unscheduled. Feedback 240 associated with downlink transmissions may be provided by the UE 115-a in accordance with a feedback procedure (e.g., HARQ ACK/NACK feedback).

In some aspects, a scheduling DCI 215 may be transmitted to the UE 115-a. The scheduling DCI 215 may provide multi-cell scheduling (e.g., multi-cell or multi-carrier PDSCH scheduling enabled by DCI formats 1_3 (for downlink scheduling) and 0_3 (for uplink scheduling)). In accordance with multi-cell scheduling, a maximum number of cells in a set may be four, and a maximum number of sets of cells from a same scheduling cell may be four. The set of cells may or may not include the scheduling cell where the UE 115-a monitors the DCI format(s) 1_3 and/or 0_3 for the set of cells, and the scheduling cell and all the cells in the set belong to the same PUCCH group and use a same numerology. In some aspects, a multi-cell scheduling DCI may provide an identification of a set of cells when multiple sets of cells configured on the scheduling cell, using a scheduled cell set indicator [0-2 bits] in the DCI format. In some cases, identification of co-scheduled cell(s) in the set of cells scheduled may indicate, in one option, a valid versus invalid frequency domain resource assignment (FDRA) value for each cell (e.g., where all the DCI fields for all the configured cells in the set are present in the DCI format, and all ‘0’s for Type-0 FDRA for a cell, and all ‘1’s for Type-1 FDRA for a cell indicates the cell is not scheduled by this DCI format); or in a second option a field “scheduled cells indicator [0-4 bits]” may provide a value from a configured table that provides a mapping between a codepoint of the indicator and co-scheduled cell(s) by the DCI format, where DCI fields only for the co-scheduled cell(s) by the DCI format are present in the DCI and a total DCI size is equal to the maximum necessary DCI size for a combination of co-scheduled cell(s) that requires maximum DCI size.

In accordance with various aspects, a size of the scheduling DCI may be adjusted based on an indication that one or more carriers will be unscheduled for a time period. In some cases, UE 115-a may receive first control information that activates a set of carriers and that indicates a scheduling information configuration (e.g., a scheduling DCI configuration) associated with the set of carriers, and that indicates a first scheduling information size. The UE 115-a may receive second control information that indicates a first subset of the set of carriers are schedulable for communications, and one or more carriers will be unscheduled for communications during a time period. Based on the first and second control information, the UE may monitor for scheduling DCI 215 in a DCI monitoring occasion. The scheduling DCI 215 may have the first scheduling information size or a second scheduling information size based on a time duration between receipt of the second control information and a start of the DCI monitoring occasion that includes the scheduling DCI 215.

In some aspects, if the second scheduling information is not received with sufficient time (e.g., by a time T1) from its application, then a subsequent scheduling DCI may still include the relevant fields for the unschedulable carrier(s), but the UE 115-a may either ignore these fields, or these fields may be repurposed to provide finer granularity of valid fields for the active scheduled carrier(s). In other aspects, the second scheduling information may be received with sufficient time (e.g., by a time T2) from its application to adjust an expected size of a scheduling DCI, and the scheduling DCI may not include fields for the unschedulable carriers. In some aspects, the timeline T2 may be a timeline sufficient to retune RF components, reconfigure BB processing, and reconfigure DCI size. In some further aspects, the second scheduling information may be received with sufficient time (e.g., by a time T3) from its application to optimize a size of a scheduling DCI to correspond to one or more combinations of schedulable carriers.

In some further aspects, a quantity of BDs or CCEs used for a scheduling DCI may be adapted based on the indication that one or more carriers will be unscheduled. In some aspects, irrespective of whether a carrier is indicated to not be scheduled, the carrier may be counted toward PDCCH BD resource budgeting at the UE 115-a.

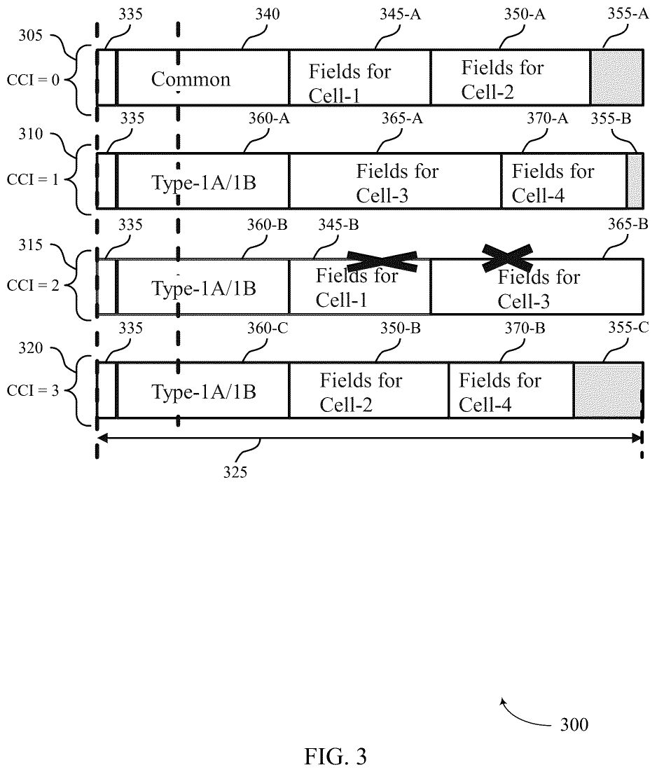

FIG. 3 shows an example of a control information configuration 300 that supports control information transmission for unscheduled carriers in wireless communications in accordance with one or more aspects of the present disclosure. Control information configuration 300 may implement or be implemented in aspects of wireless communications system 100 or wireless communications system 200. Aspects of control information configuration 300 may be implemented at or implemented by a UE or a network entity, which may be examples of the corresponding devices described herein.

In some cases, the network may indicate to or otherwise inform the UE regarding a multi-cell scheduling DCI format, which may indicate one or more combinations of carriers or cells that can be scheduled at the UE. For example, the UE may be configured with four carriers, and a value of a first field (e.g., a co-channel interference (CCI) field 335) may indicate a combination of carriers. In this example, including a first CCI value 305 (CCI=0 ) may indicate a combination of a first and second carrier, and include a common field 340, DCI fields for the first carrier 345-a, DCI fields for a second carrier 350-a, and padding bits 355-a. A second CCI value 310 (CCI=1) may indicate a combination of a third and fourth carrier, and include a Type1A/1B field 360-a, DCI fields for the third carrier 365-a, DCI fields for a fourth carrier 370-a, and padding bits 355-b. Type 1A may be a single field that indicates common information to all co-scheduled cells, and a Type 1B field type may be a single field indicating separate information to each cell of the co-scheduled cells via joint indication. A third CCI value 315 (CCI=2 ) may indicate a combination of the first and third carriers, and include a Type1A/1B field 360-b, DCI fields for the first carrier 345-b, and DCI fields for the third carrier 365-b. In this example, the DCI for the third CCI value does not include any padding bits, because this combination of fields provides a largest DCI size 325 of the configured combinations, which is set to be the scheduling DCI size for the multi-cell scheduling DCI. A fourth CCI value 320 (CCI=3 ) may indicate a combination of the second and fourth carriers, and include a Type1A/1B field 360-c, DCI fields for the second carrier 350-b, DCI fields for a fourth carrier 370-b, and padding bits 355-c.

In some aspects, as discussed with reference to FIG. 2, a UE may receive control information (e.g., an energy efficient adaptation indication or efficient scheduling indication) that indicates that one or more carriers will not be scheduled for a time period. It is noted that, while various examples herein discuss that carriers may be indicated as being schedulable or unschedulable, such indications may be provided for a carrier, cell, one or more subbands or bandwidth parts, or any combination thereof. In some aspects, the control information may be provided in DCI (that is different than a scheduling DCI), in RRC signaling, in a MAC-CE, or any combination thereof, and a timing of receipt of the control information may indicate how a UE monitors for the scheduling DCI. In some aspects, if the control information is received at a first time (e.g., a timeline T1) that is sufficient for the UE to RF retune and/or BB configure but not sufficient to reconfigure DCI, the UE may interpret the scheduling DCI as still including the relevant fields (referred to as a first set of fields) for the carriers that are indicated as being unschedulable, but the interpretation of these fields by the UE may be as follows:
the UE ignores the first set of fields, or
the first set of fields can be used for finer granularity of a second set of fields associated with the active schedulable carriers (e.g., non standby carriers).
   This can be thought of as a lightweight adaptation where the scheduling DCI fields and size are not optimized, but switching timelines or latency is prioritized.

In other aspects, if the control information is received at or before a second time (e.g., a timeline T2) that is prior to the first time, such that the second time is sufficient to adapt a DCI size, the scheduling DCI may not include fields for the cells that are indicated as being unschedulable for the time period. In the example of FIG. 3, the control information may indicate that cell 1 and cell 3 are in standby (e.g., are unschedulable), and the scheduling DCI with the third CCI value 315 (CCI=2 ) that indicates the combination of the first and third carriers will not include fields associated with the first and third carriers. In such cases, the DCI fields for the first carrier 345-b and DCI fields for the third carrier 365-b may all be set to padding values (e.g., all ‘0’s or all ‘1’s). In some aspects, the first time, the second time, and the third time as will be discussed below, may be determined based on an indicated UE capability that provides timelines for adjusting scheduling DCIs. In further aspects, if the control information is received at or before a third time (e.g., a timeline T3) that is prior to the second time, such that the third time is further sufficient to optimize the scheduling DCI size, the scheduling DCI size may be adjusted in accordance with schedulable carriers. In such aspects, the scheduling DCI may not include DCI fields for the cells that are indicated as being unschedulable for the time period, and a size of the scheduling DCI may be optimized based on the remaining cells that are schedulable during the time period. In some cases, the time period may be a period until a subsequent control information message is received that changes the schedulable carriers (e.g., the indication of schedulable and unschedulable cells is semi-static). In some aspects, the third timeline (T3) is greater than T1 and T2.

In some aspects, the total scheduling DCI payload size may be based on a combination of active schedulable carriers that results in the largest payload, and active standby carriers are not accounted for. In some aspects, the UE may be configured with a table providing mapping between a codepoint of the indicator of the CCI field 335 and co-scheduled cell(s), and not for the standby carriers. In such aspects, DCI fields only for the co-scheduled active schedulable carrier(s), and not for the standby carriers, may be included in the scheduling DCI (e.g., in DCI format 0_3/1_3). In such aspects, a total scheduling DCI size may be equal to the maximum necessary DCI size for the combination of co-scheduled active schedulable carrier(s) and not for the carriers that are indicated as being unschedulable.

In some aspects, for identification of co-scheduled carrier(s) in the set of carriers scheduled by the scheduling DCI (e.g., DCI format 0_3/1_3), there may be a valid versus invalid FDRA value for each cell. In some aspects, when the control information that indicates the unschedulable carriers is received at or prior to the second or third time, the UE may not expect FDRA fields for the standby carriers, and when the control information is received after the first time, the scheduling DCI may include these FDRA fields for the standby carriers, but the FDRA value for these fields may be set to a predetermined value (e.g., all ‘0’s or all ‘1’s). In some aspects, the UE may report a capability (e.g., timelines, fast and slow) with the corresponding behavior. In other aspects, UE timeline support may be captured as a mode of operation, such as mode 1 in which DCI size is larger, but latency requirement is more important, or mode 2 in which there is a sufficient timeline and prioritize compact DCI.

In some further aspects, a maximum number of BDs or CCEs can be adapted based on the control information that indicates one or more carriers are unschedulable for the time period. In some aspects, if a UE processing budget for BDs is split between the scheduling carrier and other carriers, then whenever the UE receives the control information that indicates unschedulable carriers, the processing budget on the other active carriers can be increased. In other aspects, no matter whether a carrier is indicated as unschedulable or not, the carrier is still counted towards PDCCH BD budgeting.

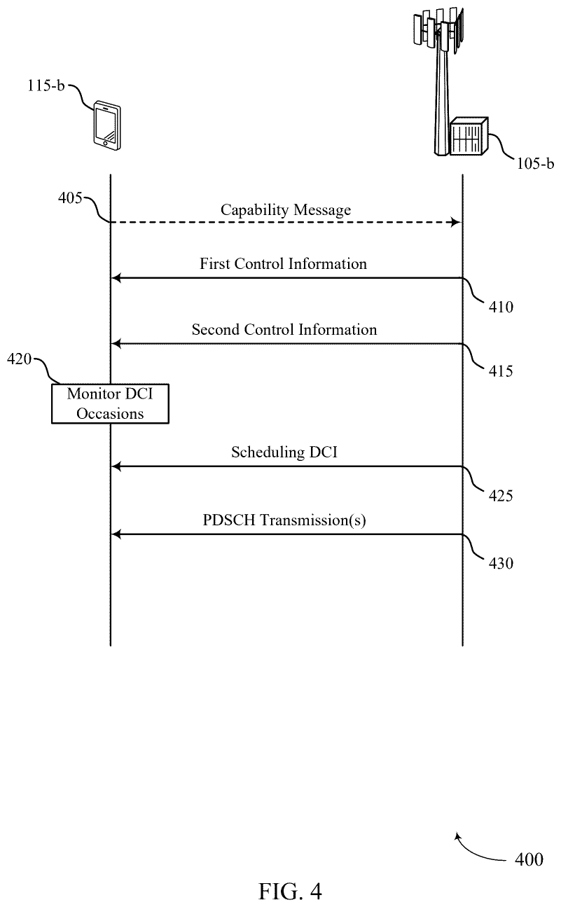

FIG. 4 shows an example of a process flow 400 that supports control information transmission for unscheduled carriers in wireless communications in accordance with one or more aspects of the present disclosure. The process flow 400 may implement or may be implemented by aspects of the wireless communications system 100, the wireless communications system 200, or the control information configuration 300. For example, the process flow 400 may include a UE 115-b and a network entity 105-b, which may be examples of corresponding devices described herein.

Optionally, at 405, the UE 115-b may transmit, and the network entity 105-b may receive, a capability message that indicates a capability of the UE 115-b to support adjustment of a scheduling DCI size following receipt of control information that indicates one or more carriers are unschedulable for a time period. In some aspects, the capability message may indicate one or more timelines, such as T1, T2, and T3, as discussed herein.

At 410, the network entity 105-b may transmit, and the UE 115-b may receive, first control information. The first control information may configure a set of CCs at the UE 115-b. Further, the first control information may configure a scheduling DCI based on one or more combinations of CCs that can be scheduled concurrently, in accordance with techniques as discussed herein.

At 415, the network entity 105-b may transmit, and the UE 115-b may receive, second control information. The second control information may may indicate that one or more carriers of the set of carriers are unschedulable for a time period. The second control information may be provided in one or more of DCI, a MAC-CE, or RRC signaling, and may indicate that the one or more carriers are active standby carriers, in accordance with techniques as discussed herein. In some aspects, based on a timing of the second control information relative to a subsequent scheduling DCI (e.g., if a T3 timeline is met), the second control information may also reconfigure a scheduling DCI size based on one or more combinations of active schedulable carriers are present.

At 420, the UE 115-b may monitor one or more scheduling DCI occasions. In some aspects, the UE 115-b may monitor for DCI based on BDs in accordance with a scheduling DCI size, where the scheduling DCI size may be determined in accordance with techniques as discussed herein. At 425, the network entity 105-b may transmit, and the UE 115-b may receive, a scheduling DCI. The scheduling DCI may include one or more fields, and have a DCI size, that is based on the configured carriers that may be schedulable, or both schedulable and unschedulable carriers, in accordance with techniques as discussed herein. At 430, the network entity 105-b may transmit, and the UE 115-b may receive, one or more PDSCH transmissions in accordance with the scheduling DCI.

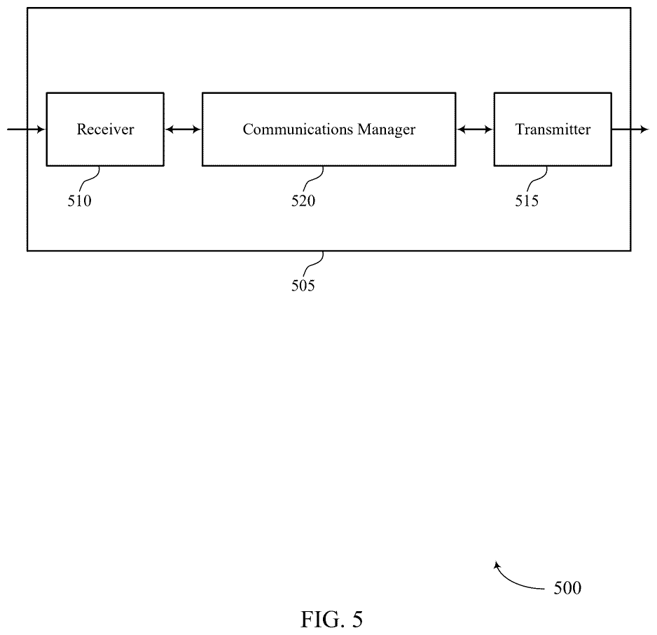

FIG. 5 shows a block diagram 500 of a device 505 that supports control information transmission for unscheduled carriers in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to control information transmission for unscheduled carriers in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to control information transmission for unscheduled carriers in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of control information transmission for unscheduled carriers in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The communications manager 520 is capable of, configured to, or operable to support a means for receiving second control information that indicates a first subset of the set of carriers are schedulable for communications during at least a first time period and one or more carriers of the set of carriers will be unscheduled for communications during at least the first time period. The communications manager 520 is capable of, configured to, or operable to support a means for monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for scheduling DCI interpretation when one or more CCs are indicated as being unscheduled for a time period, which may enhance UE operation by reducing power consumption and processing resource usage, and which may provide more efficient utilization of communication resources through reduced overhead associated with scheduling DCIs.

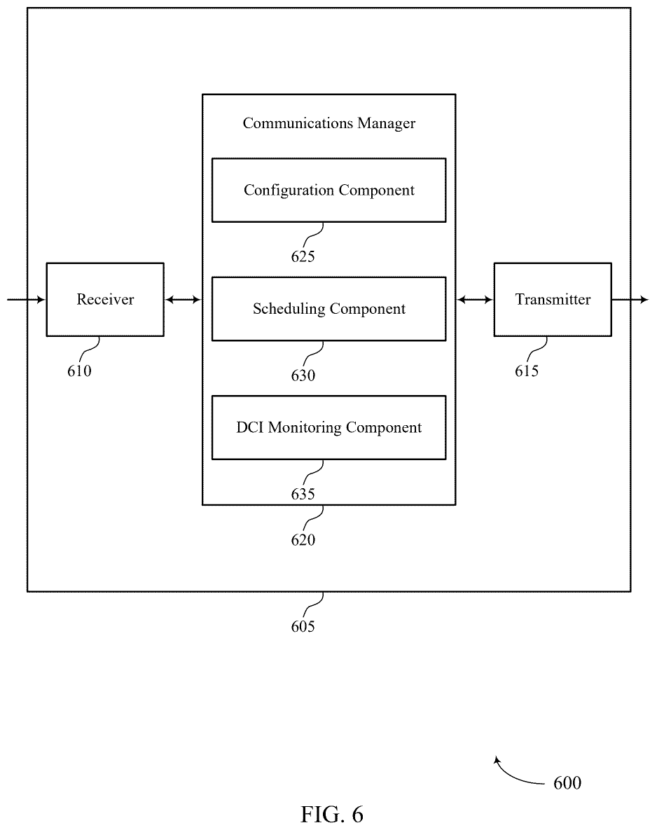

FIG. 6 shows a block diagram 600 of a device 605 that supports control information transmission for unscheduled carriers in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to control information transmission for unscheduled carriers in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to control information transmission for unscheduled carriers in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of control information transmission for unscheduled carriers in wireless communications as described herein. For example, the communications manager 620 may include a configuration component 625, a scheduling component 630, a DCI monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The scheduling component 630 is capable of, configured to, or operable to support a means for receiving second control information that indicates a first subset of the set of carriers are schedulable for communications during at least a first time period and one or more carriers of the set of carriers will be unscheduled for communications during at least the first time period. The DCI monitoring component 635 is capable of, configured to, or operable to support a means for monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

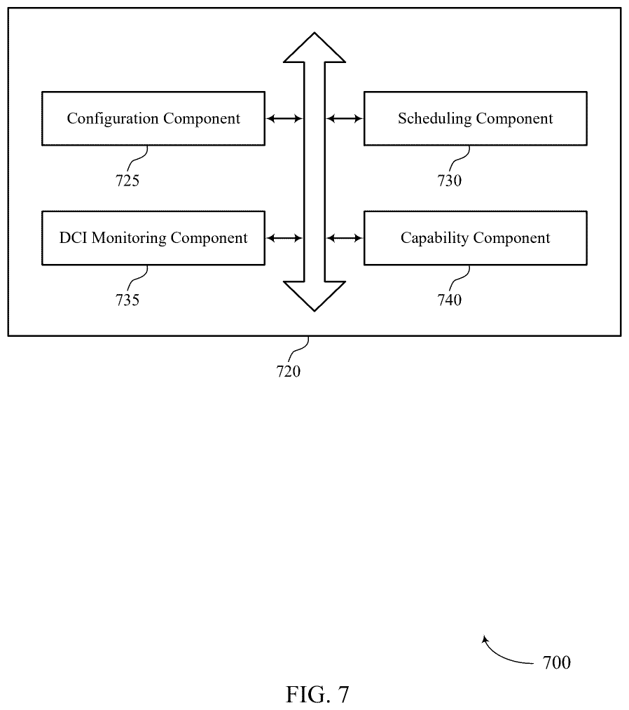

FIG. 7 shows a block diagram 700 of a communications manager 720 that supports control information transmission for unscheduled carriers in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of control information transmission for unscheduled carriers in wireless communications as described herein. For example, the communications manager 720 may include a configuration component 725, a scheduling component 730, a DCI monitoring component 735, a capability component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The scheduling component 730 is capable of, configured to, or operable to support a means for receiving second control information that indicates a first subset of the set of carriers are schedulable for communications during at least a first time period and one or more carriers of the set of carriers will be unscheduled for communications during at least the first time period. The DCI monitoring component 735 is capable of, configured to, or operable to support a means for monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

In some examples, the scheduling information in the downlink control information monitoring occasion has the first scheduling information size when the time duration between receipt of the second control information and the start of the downlink control information monitoring occasion is less than a first time threshold value.

In some examples, to support monitoring, the DCI monitoring component 735 is capable of, configured to, or operable to support a means for receiving the scheduling information in the downlink control information monitoring occasion. In some examples, to support monitoring, the DCI monitoring component 735 is capable of, configured to, or operable to support a means for ignoring one or more fields of the scheduling information that are associated with the one or more carriers that are unscheduled for communications.

In some examples, to support monitoring, the DCI monitoring component 735 is capable of, configured to, or operable to support a means for receiving the scheduling information in the downlink control information monitoring occasion in a first subset of fields associated with the first subset of the set of carriers and in a second subset of fields associated with the one or more carriers that are unscheduled for communications, where the second subset of fields include additional information associated with the first subset of carriers. In some examples, the scheduling information in the downlink control information monitoring occasion has the second scheduling information size when the time duration between receipt of the second control information and the start of the downlink control information monitoring occasion exceeds a second time threshold value, and where the second scheduling information size is based on one or more fields associated with the first carrier being omitted from the scheduling information.

In some examples, the capability component 740 is capable of, configured to, or operable to support a means for transmitting an indication of one or more timelines that are supported at the UE for switching the first scheduling information size to the second scheduling information size. In some examples, the scheduling information in the downlink control information monitoring occasion has the second scheduling information size when the time duration between receipt of the second control information and the start of the downlink control information monitoring occasion exceeds a third time threshold value, and where the second scheduling information size is associated with one or more combinations of carriers of the first subset of the set of carriers. In some examples, the second scheduling information size is based on a first combination of two or more combinations of carriers of the subset of carriers that can be scheduled during the first time period, the first combination associated with a largest payload size of two or more payload sizes associated with the two or more combinations of carriers of the subset of carriers. In some examples, the second control information includes a table that provides a mapping between a codepoint that is provided in the scheduling information and one or more scheduled carriers of the subset of carriers.

In some examples, the second scheduling information size is based on a first subset of fields associated with the first subset of the set of carriers. In some examples, the second scheduling information size corresponds to a payload size associated with the first combination of the two or more combinations of carriers of the subset of carriers that can be scheduled during the first time period.

In some examples, the scheduling information does not include frequency domain resource assignment fields when the time duration between receipt of the second control information and the start of the downlink control information monitoring occasion exceeds a time threshold value. In some examples, the scheduling information includes frequency domain resource assignment fields when the time duration between receipt of the second control information and the start of the downlink control information monitoring occasion is less than a time threshold value, and where one or more frequency domain resource assignment fields associated with the first carrier are set to a predetermined value.

In some examples, the time duration between receipt of the second control information and the start of the downlink control information monitoring occasion that indicates the first scheduling information size or the second scheduling information size is based on a capability reported by the UE or a mode of operation indicated by a network entity.

In some examples, to support monitoring, the DCI monitoring component 735 is capable of, configured to, or operable to support a means for attempting to decode the scheduling information from two or more sets of candidate control channel elements, where a quantity of sets of candidate control channel elements is based on the second control information. In some examples, a downlink control channel blind decoding budget is determined in accordance with the set of carriers irrespective of whether one or more carriers is indicated to be unscheduled for communications during at least the first time period.

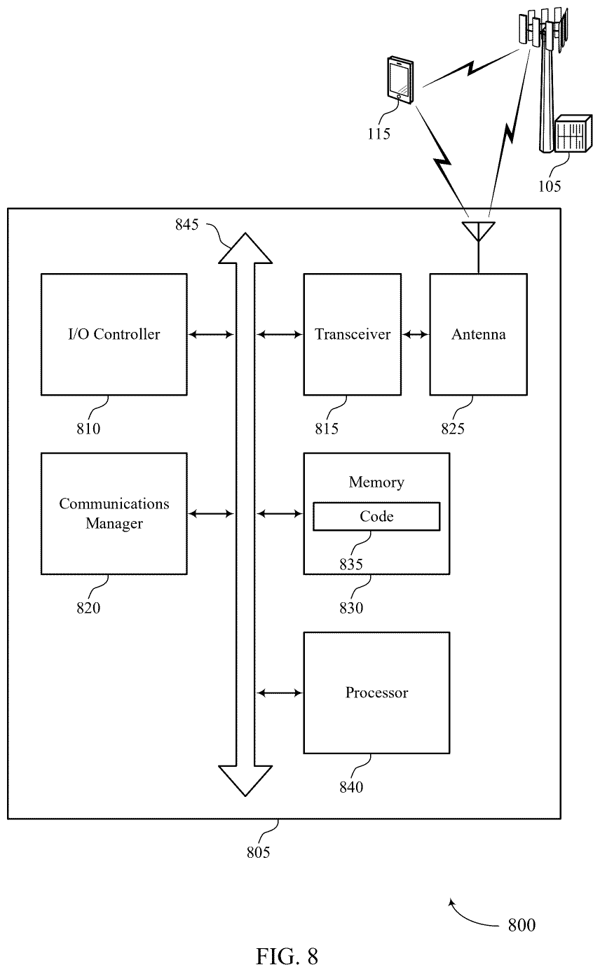

FIG. 8 shows a diagram of a system 800 including a device 805 that supports control information transmission for unscheduled carriers in wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting control information transmission for unscheduled carriers in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The communications manager 820 is capable of, configured to, or operable to support a means for receiving second control information that indicates a first subset of the set of carriers are schedulable for communications during at least a first time period and one or more carriers of the set of carriers will be unscheduled for communications during at least the first time period. The communications manager 820 is capable of, configured to, or operable to support a means for monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size.

By including or configuring the communications manager 820 in accordance with examples as described herein, the device 805 may support techniques for scheduling DCI interpretation when one or more CCs are indicated as being unscheduled for a time period, which may enhance UE operation by reducing power consumption and processing resource usage, and which may provide more efficient utilization of communication resources through reduced overhead associated with scheduling DCIs.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of control information transmission for unscheduled carriers in wireless communications as described herein, or the at least one processor 840 and the at least one memory 830 may be otherwise configured to, individually or collectively, perform or support such operations.

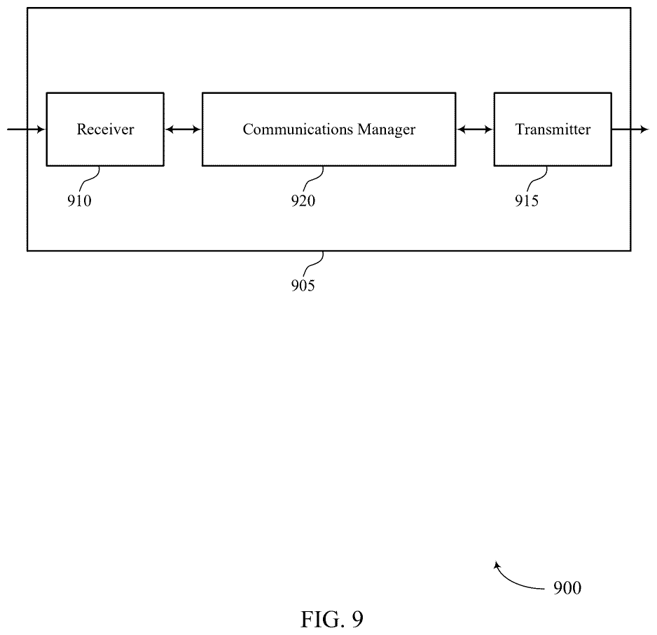

FIG. 9 shows a block diagram 900 of a device 905 that supports control information transmission for unscheduled carriers in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of control information transmission for unscheduled carriers in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The communications manager 920 is capable of, configured to, or operable to support a means for outputting second control information that indicates a first subset of the set of carriers are schedulable for communications during at least a first time period and one or more carriers of the set of carriers will be unscheduled for communications during at least the first time period. The communications manager 920 is capable of, configured to, or operable to support a means for outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for scheduling DCI interpretation when one or more CCs are indicated as being unscheduled for a time period, which may enhance UE operation by reducing power consumption and processing resource usage, and which may provide more efficient utilization of communication resources through reduced overhead associated with scheduling DCIs.

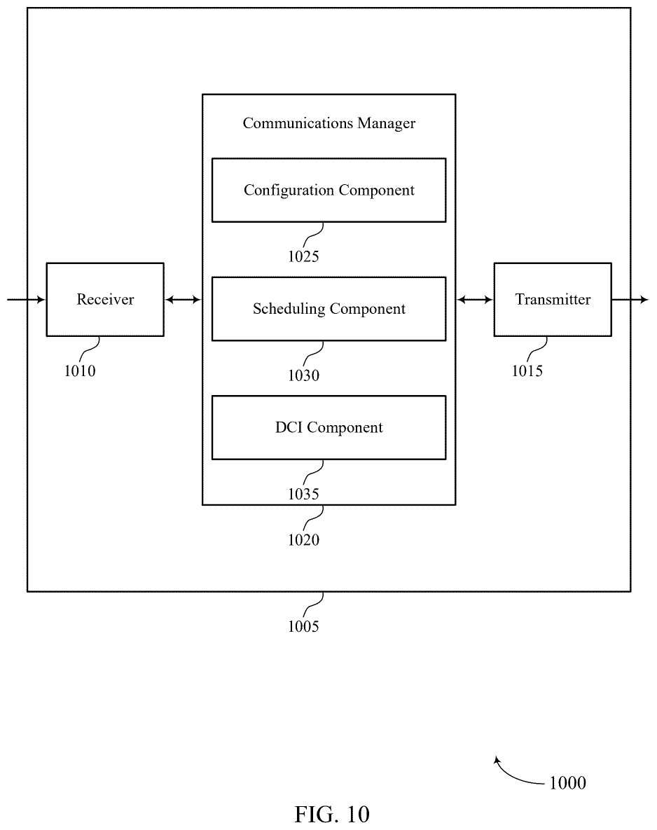

FIG. 10 shows a block diagram 1000 of a device 1005 that supports control information transmission for unscheduled carriers in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of control information transmission for unscheduled carriers in wireless communications as described herein. For example, the communications manager 1020 may include a configuration component 1025, a scheduling component 1030, a DCI component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The scheduling component 1030 is capable of, configured to, or operable to support a means for outputting second control information that indicates a first subset of the set of carriers are schedulable for communications during at least a first time period and one or more carriers of the set of carriers will be unscheduled for communications during at least the first time period. The DCI component 1035 is capable of, configured to, or operable to support a means for outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

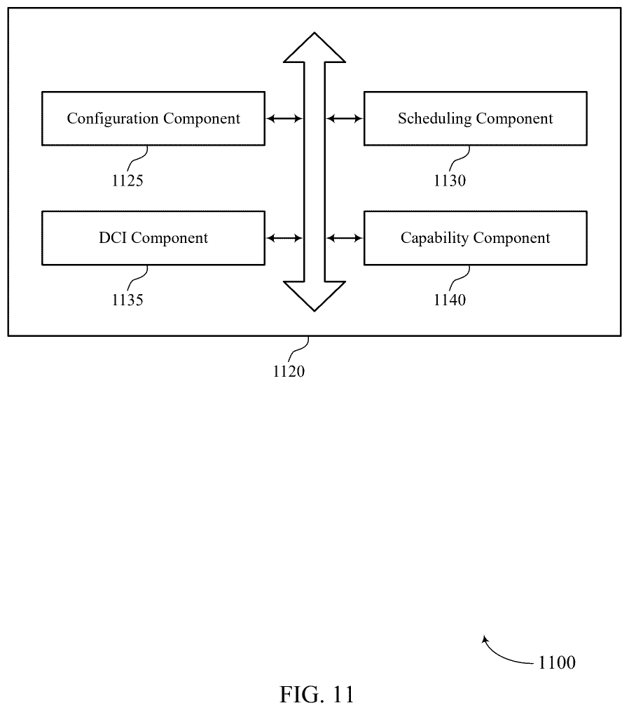

FIG. 11 shows a block diagram 1100 of a communications manager 1120 that supports control information transmission for unscheduled carriers in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of control information transmission for unscheduled carriers in wireless communications as described herein. For example, the communications manager 1120 may include a configuration component 1125, a scheduling component 1130, a DCI component 1135, a capability component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration component 1125 is capable of, configured to, or operable to support a means for outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The scheduling component 1130 is capable of, configured to, or operable to support a means for outputting second control information that indicates a first subset of the set of carriers are schedulable for communications during at least a first time period and one or more carriers of the set of carriers will be unscheduled for communications during at least the first time period. The DCI component 1135 is capable of, configured to, or operable to support a means for outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

In some examples, the scheduling information in the downlink control information monitoring occasion has the first scheduling information size when the time duration between the second control information and the start of the downlink control information monitoring occasion is less than a first time threshold value. In some examples, one or more fields of the scheduling information that are associated with the one or more carriers that are unscheduled for communications are ignored.

In some examples, the scheduling information in the downlink control information monitoring occasion includes a first subset of fields associated with the first subset of the set of carriers and a second subset of fields associated with the one or more carriers that are unscheduled for communications, where the second subset of fields include additional information associated with the first subset of carriers. In some examples, the scheduling information in the downlink control information monitoring occasion has the second scheduling information size when the time duration between the second control information and the start of the downlink control information monitoring occasion exceeds a second time threshold value, and where the second scheduling information size is based on one or more fields associated with the first carrier being omitted from the scheduling information.

In some examples, the capability component 1140 is capable of, configured to, or operable to support a means for obtaining an indication of one or more timelines that are supported at the UE for switching the first scheduling information size to the second scheduling information size. In some examples, the scheduling information in the downlink control information monitoring occasion has the second scheduling information size when the time duration between receipt of the second control information and the start of the downlink control information monitoring occasion exceeds a third time threshold value, and where the second scheduling information size is associated with one or more combinations of carriers of the first subset of the set of carriers. In some examples, the second scheduling information size is based on a first combination of two or more combinations of carriers of the subset of carriers that can be scheduled during the first time period, the first combination associated with a largest payload size of two or more payload sizes associated with the two or more combinations of carriers of the subset of carriers. In some examples, the second control information includes a table that provides a mapping between a codepoint that is provided in the scheduling information and one or more scheduled carriers of the subset of carriers.

In some examples, the second scheduling information size is based on a first subset of fields associated with the first subset of the set of carriers. In some examples, the second scheduling information size corresponds to a payload size associated with the first combination of the two or more combinations of carriers of the subset of carriers that can be scheduled during the first time period.

In some examples, the scheduling information does not include frequency domain resource assignment fields when the time duration between the second control information and the start of the downlink control information monitoring occasion exceeds a time threshold value. In some examples, the scheduling information includes frequency domain resource assignment fields when the time duration between the second control information and the start of the downlink control information monitoring occasion is less than a time threshold value, and where one or more frequency domain resource assignment fields associated with the first carrier are set to a predetermined value.

In some examples, the time duration between the second control information and the start of the downlink control information monitoring occasion that indicates the first scheduling information size or the second scheduling information size is based on a capability reported by the UE or a mode of operation indicated by the network entity. In some examples, the downlink control information is provided in a set of control channel elements of two or more sets of candidate control channel elements, and a quantity of sets of candidate control channel elements is based on the second control information. In some examples, a downlink control channel blind decoding budget at the UE is determined in accordance with the set of carriers irrespective of whether one or more carriers is indicated to be unscheduled for communications during at least the first time period.

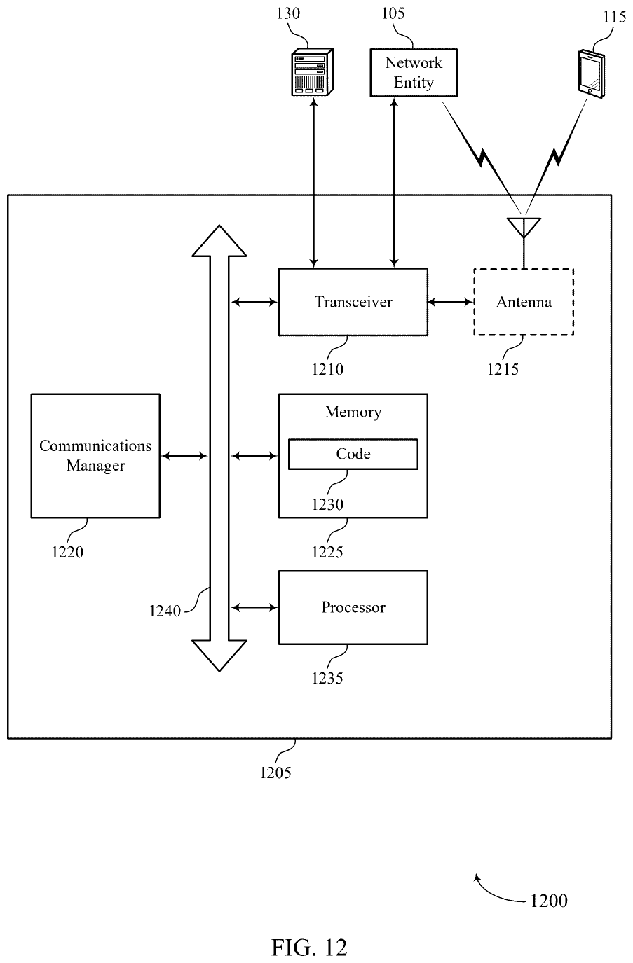

FIG. 12 shows a diagram of a system 1200 including a device 1205 that supports control information transmission for unscheduled carriers in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting control information transmission for unscheduled carriers in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The communications manager 1220 is capable of, configured to, or operable to support a means for outputting second control information that indicates a first subset of the set of carriers are schedulable for communications during at least a first time period and one or more carriers of the set of carriers will be unscheduled for communications during at least the first time period. The communications manager 1220 is capable of, configured to, or operable to support a means for outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size.

By including or configuring the communications manager 1220 in accordance with examples as described herein, the device 1205 may support techniques for scheduling DCI interpretation when one or more CCs are indicated as being unscheduled for a time period, which may enhance UE operation by reducing power consumption and processing resource usage, and which may provide more efficient utilization of communication resources through reduced overhead associated with scheduling DCIs.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of control information transmission for unscheduled carriers in wireless communications as described herein, or the at least one processor 1235 and the at least one memory 1225 may be otherwise configured to, individually or collectively, perform or support such operations.

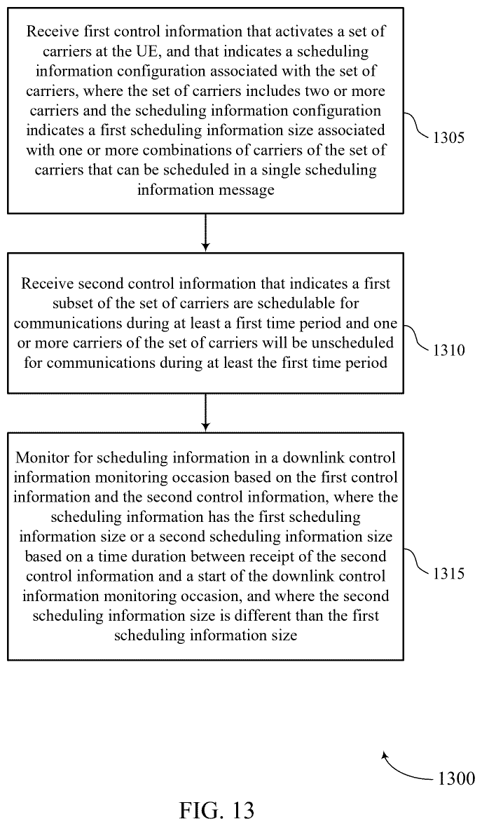

FIG. 13 shows a flowchart illustrating a method 1300 that supports control information transmission for unscheduled carriers in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first control information that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The operations of 1305 may be performed in accordance with examples as disclosed herein. In some examples, aspects of the operations of 1305 may be performed by a configuration component 725 as described with reference to FIG. 7.

At 1310, the method may include receiving second control information that indicates a first subset of the set of carriers are schedulable for communications during at least a first time period and one or more carriers of the set of carriers will be unscheduled for communications during at least the first time period. The operations of 1310 may be performed in accordance with examples as disclosed herein. In some examples, aspects of the operations of 1310 may be performed by a scheduling component 730 as described with reference to FIG. 7.

At 1315, the method may include monitoring for scheduling information in a downlink control information monitoring occasion based on the first control information and the second control information, where the scheduling information has the first scheduling information size or a second scheduling information size based on a time duration between receipt of the second control information and a start of the downlink control information monitoring occasion, and where the second scheduling information size is different than the first scheduling information size. The operations of 1315 may be performed in accordance with examples as disclosed herein. In some examples, aspects of the operations of 1315 may be performed by a DCI monitoring component 735 as described with reference to FIG. 7.

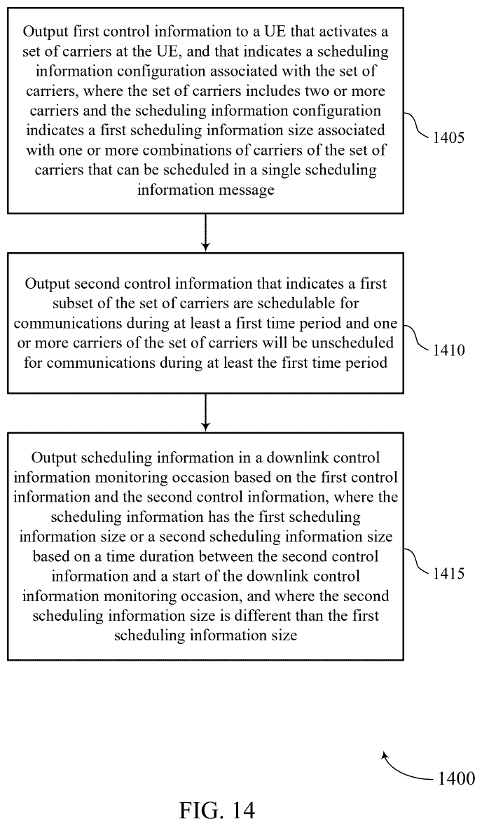

FIG. 14 shows a flowchart illustrating a method 1400 that supports control information transmission for unscheduled carriers in wireless communications in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting first control information to a UE that activates a set of carriers at the UE, and that indicates a scheduling information configuration associated with the set of carriers, where the set of carriers includes two or more carriers and the scheduling information configuration indicates a first scheduling information size associated with one or more combinations of carriers of the set of carriers that can be scheduled in a single scheduling information message. The operations of 1405 may be performed in accordance with examples as disclosed herein. In some examples, aspects of the operations of 1405 may be performed by a configuration component 1125 as described with reference to FIG. 11.

At 1410, the method may include outputting second control information that indicates a first subset of the set of carriers are schedulable for communications during at least a first time period and one or more carriers of the set of carriers will be unscheduled for communications during at least the first time period. The operations of 1410 may be performed in accordance with examples as disclosed herein. In some examples, aspects of the operations of 1410 may be performed by a scheduling component 1130 as described with reference to FIG. 11.

At 1415, the method may include outputting scheduling information in a downlink control information monitoring occasion based on the first control information and the second control information, where the scheduling information has the first scheduling information size or a second scheduling information size based on a time duration between the second control information and a start of the downlink control information monitoring occasion, and where the second scheduling information size is different than the first scheduling information size. The operations of 1415 may be performed in accordance with examples as disclosed herein. In some examples, aspects of the operations of 1415 may be performed by a DCI component 1135 as described with reference to FIG. 11.

The following provides an overview of aspects of the present disclosure:

Aspect 1: A method for wireless communications at a UE, comprising: receiving first control information that activates a set of carriers at the UE, and that indicates a scheduling information configuration associated with the set of carriers, wherein the set of carriers includes two or more carriers and the scheduling information configuration indicates a first scheduling information size associated with one or more combinations of carriers of the set of carriers that can be scheduled in a single scheduling information message; receiving second control information that indicates a first subset of the set of carriers are schedulable for communications during at least a first time period and one or more carriers of the set of carriers will be unscheduled for communications during at least the first time period; and monitoring for scheduling information in a downlink control information monitoring occasion based at least in part on the first control information and the second control information, wherein the scheduling information has the first scheduling information size or a second scheduling information size based at least in part on a time duration between receipt of the second control information and a start of the downlink control information monitoring occasion, and wherein the second scheduling information size is different than the first scheduling information size.

Aspect 2: The method of aspect 1, wherein the scheduling information in the downlink control information monitoring occasion has the first scheduling information size when the time duration between receipt of the second control information and the start of the downlink control information monitoring occasion is less than a first time threshold value.

Aspect 3: The method of aspect 2, wherein the monitoring comprises: receiving the scheduling information in the downlink control information monitoring occasion; and ignoring one or more fields of the scheduling information that are associated with the one or more carriers that are unscheduled for communications.

Aspect 4: The method of aspect 2, wherein the monitoring comprises: receiving the scheduling information in the downlink control information monitoring occasion in a first subset of fields associated with the first subset of the set of carriers and in a second subset of fields associated with the one or more carriers that are unscheduled for communications, wherein the second subset of fields include additional information associated with the first subset of carriers.

Aspect 5: The method of any of aspects 1 through 4, wherein the scheduling information in the downlink control information monitoring occasion has the second scheduling information size when the time duration between receipt of the second control information and the start of the downlink control information monitoring occasion exceeds a second time threshold value, and wherein the second scheduling information size is based at least in part on one or more fields associated with the first carrier being omitted from the scheduling information.

Aspect 6: The method of any of aspects 1 through 5, further comprising: transmitting an indication of one or more timelines that are supported at the UE for switching the first scheduling information size to the second scheduling information size.

Aspect 7: The method of any of aspects 1 through 6, wherein the scheduling information in the downlink control information monitoring occasion has the second scheduling information size when the time duration between receipt of the second control information and the start of the downlink control information monitoring occasion exceeds a third time threshold value, and wherein the second scheduling information size is associated with one or more combinations of carriers of the first subset of the set of carriers.

Aspect 8: The method of any of aspects 1 through 7, wherein the second scheduling information size is based at least in part on a first combination of two or more combinations of carriers of the subset of carriers that can be scheduled during the first time period, the first combination associated with a largest payload size of two or more payload sizes associated with the two or more combinations of carriers of the subset of carriers.

Aspect 9: The method of aspect 8, wherein the second control information includes a table that provides a mapping between a codepoint that is provided in the scheduling information and one or more scheduled carriers of the subset of carriers.

Aspect 10: The method of any of aspects 8 through 9, wherein the second scheduling information size is based at least in part on a first subset of fields associated with the first subset of the set of carriers.

Aspect 11: The method of aspect 10, wherein the second scheduling information size corresponds to a payload size associated with the first combination of the two or more combinations of carriers of the subset of carriers that can be scheduled during the first time period.

Aspect 12: The method of any of aspects 1 through 11, wherein the scheduling information does not include frequency domain resource assignment fields when the time duration between receipt of the second control information and the start of the downlink control information monitoring occasion exceeds a time threshold value.

Aspect 13: The method of any of aspects 1 through 12, wherein the scheduling information includes frequency domain resource assignment fields when the time duration between receipt of the second control information and the start of the downlink control information monitoring occasion is less than a time threshold value, and wherein one or more frequency domain resource assignment fields associated with the first carrier are set to a predetermined value.

Aspect 14: The method of any of aspects 1 through 13, wherein the time duration between receipt of the second control information and the start of the downlink control information monitoring occasion that indicates the first scheduling information size or the second scheduling information size is based at least in part on a capability reported by the UE or a mode of operation indicated by a network entity.

Aspect 15: The method of any of aspects 1 through 14, wherein the monitoring comprises: attempting to decode the scheduling information from two or more sets of candidate control channel elements, wherein a quantity of sets of candidate control channel elements is based at least in part on the second control information.

Aspect 16: The method of aspect 15, wherein a downlink control channel blind decoding budget is determined in accordance with the set of carriers irrespective of whether one or more carriers is indicated to be unscheduled for communications during at least the first time period.

Aspect 17: A method for wireless communications at a network entity, comprising: outputting first control information to a UE that activates a set of carriers at the UE, and that indicates a scheduling information configuration associated with the set of carriers, wherein the set of carriers includes two or more carriers and the scheduling information configuration indicates a first scheduling information size associated with one or more combinations of carriers of the set of carriers that can be scheduled in a single scheduling information message; outputting second control information that indicates a first subset of the set of carriers are schedulable for communications during at least a first time period and one or more carriers of the set of carriers will be unscheduled for communications during at least the first time period; and outputting scheduling information in a downlink control information monitoring occasion based at least in part on the first control information and the second control information, wherein the scheduling information has the first scheduling information size or a second scheduling information size based at least in part on a time duration between the second control information and a start of the downlink control information monitoring occasion, and wherein the second scheduling information size is different than the first scheduling information size.

Aspect 18: The method of aspect 17, wherein the scheduling information in the downlink control information monitoring occasion has the first scheduling information size when the time duration between the second control information and the start of the downlink control information monitoring occasion is less than a first time threshold value.

Aspect 19: The method of aspect 18, wherein one or more fields of the scheduling information that are associated with the one or more carriers that are unscheduled for communications are ignored.

Aspect 20: The method of aspect 18, wherein the scheduling information in the downlink control information monitoring occasion includes a first subset of fields associated with the first subset of the set of carriers and a second subset of fields associated with the one or more carriers that are unscheduled for communications, wherein the second subset of fields include additional information associated with the first subset of carriers.

Aspect 21: The method of any of aspects 17 through 20, wherein the scheduling information in the downlink control information monitoring occasion has the second scheduling information size when the time duration between the second control information and the start of the downlink control information monitoring occasion exceeds a second time threshold value, and wherein the second scheduling information size is based at least in part on one or more fields associated with the first carrier being omitted from the scheduling information.

Aspect 22: The method of any of aspects 17 through 21, further comprising: obtaining an indication of one or more timelines that are supported at the UE for switching the first scheduling information size to the second scheduling information size.

Aspect 23: The method of any of aspects 17 through 22, wherein the scheduling information in the downlink control information monitoring occasion has the second scheduling information size when the time duration between receipt of the second control information and the start of the downlink control information monitoring occasion exceeds a third time threshold value, and wherein the second scheduling information size is associated with one or more combinations of carriers of the first subset of the set of carriers.

Aspect 24: The method of any of aspects 17 through 23, wherein the second scheduling information size is based at least in part on a first combination of two or more combinations of carriers of the subset of carriers that can be scheduled during the first time period, the first combination associated with a largest payload size of two or more payload sizes associated with the two or more combinations of carriers of the subset of carriers.

Aspect 25: The method of aspect 24, wherein the second control information includes a table that provides a mapping between a codepoint that is provided in the scheduling information and one or more scheduled carriers of the subset of carriers.

Aspect 26: The method of any of aspects 24 through 25, wherein the second scheduling information size is based at least in part on a first subset of fields associated with the first subset of the set of carriers.

Aspect 27: The method of aspect 26, wherein the second scheduling information size corresponds to a payload size associated with the first combination of the two or more combinations of carriers of the subset of carriers that can be scheduled during the first time period.

Aspect 28: The method of any of aspects 17 through 27, wherein the scheduling information does not include frequency domain resource assignment fields when the time duration between the second control information and the start of the downlink control information monitoring occasion exceeds a time threshold value.

Aspect 29: The method of any of aspects 17 through 28, wherein the scheduling information includes frequency domain resource assignment fields when the time duration between the second control information and the start of the downlink control information monitoring occasion is less than a time threshold value, and wherein one or more frequency domain resource assignment fields associated with the first carrier are set to a predetermined value.

Aspect 30: The method of any of aspects 17 through 29, wherein the time duration between the second control information and the start of the downlink control information monitoring occasion that indicates the first scheduling information size or the second scheduling information size is based at least in part on a capability reported by the UE or a mode of operation indicated by the network entity.

Aspect 31: The method of any of aspects 17 through 30, wherein the downlink control information is provided in a set of control channel elements of two or more sets of candidate control channel elements, and a quantity of sets of candidate control channel elements is based at least in part on the second control information.

Aspect 32: The method of aspect 31, wherein a downlink control channel blind decoding budget at the UE is determined in accordance with the set of carriers irrespective of whether one or more carriers is indicated to be unscheduled for communications during at least the first time period.

Aspect 33: A UE for wireless communications, comprising one or more memories storing processor-executable code, and one or more processors coupled with the one or more memories and individually or collectively operable to execute the code to cause the UE to perform a method of any of aspects 1 through 16.

Aspect 34: A UE for wireless communications, comprising at least one means for performing a method of any of aspects 1 through 16.

Aspect 35: A non-transitory computer-readable medium storing code for wireless communications, the code comprising instructions executable by one or more processors to perform a method of any of aspects 1 through 16.

Aspect 36: A network entity for wireless communications, comprising one or more memories storing processor-executable code, and one or more processors coupled with the one or more memories and individually or collectively operable to execute the code to cause the network entity to perform a method of any of aspects 17 through 32.

Aspect 37: A network entity for wireless communications, comprising at least one means for performing a method of any of aspects 17 through 32.

Aspect 38: A non-transitory computer-readable medium storing code for wireless communications, the code comprising instructions executable by one or more processors to perform a method of any of aspects 17 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control information that activates a set of carriers at the UE, and that indicates a scheduling information configuration associated with the set of carriers, wherein the set of carriers includes two or more carriers and the scheduling information configuration indicates a first scheduling information size associated with one or more combinations of carriers of the set of carriers that can be scheduled in a single scheduling information message;
receive second control information that indicates a first subset of the set of carriers are schedulable for communications during at least a first time period and one or more carriers of the set of carriers will be unscheduled for communications during at least the first time period; and
monitor for scheduling information in a downlink control information monitoring occasion based at least in part on the first control information and the second control information, wherein the scheduling information has the first scheduling information size or a second scheduling information size based at least in part on a time duration between receipt of the second control information and a start of the downlink control information monitoring occasion, and wherein the second scheduling information size is different than the first scheduling information size.

2. The UE of claim 1, wherein the scheduling information in the downlink control information monitoring occasion has the first scheduling information size when the time duration between receipt of the second control information and the start of the downlink control information monitoring occasion is less than a first time threshold value.

3. The UE of claim 2, wherein, to monitor, the one or more processors are individually or collectively operable to execute the code to cause the UE to:
receive the scheduling information in the downlink control information monitoring occasion; and
ignore one or more fields of the scheduling information that are associated with the one or more carriers that are unscheduled for communications.

4. The UE of claim 2, wherein, to monitor, the one or more processors are individually or collectively operable to execute the code to cause the UE to:
receive the scheduling information in the downlink control information monitoring occasion in a first subset of fields associated with the first subset of the set of carriers and in a second subset of fields associated with the one or more carriers that are unscheduled for communications, wherein the second subset of fields include additional information associated with the first subset of carriers.

5. The UE of claim 1, wherein the scheduling information in the downlink control information monitoring occasion has the second scheduling information size when the time duration between receipt of the second control information and the start of the downlink control information monitoring occasion exceeds a second time threshold value, and wherein the second scheduling information size is based at least in part on one or more fields associated with the first carrier being omitted from the scheduling information.

6. The UE of claim 1, wherein the one or more processors are individually or collectively further operable to execute the code to cause the UE to:
transmit an indication of one or more timelines that are supported at the UE for switching the first scheduling information size to the second scheduling information size.

7. The UE of claim 1, wherein the scheduling information in the downlink control information monitoring occasion has the second scheduling information size when the time duration between receipt of the second control information and the start of the downlink control information monitoring occasion exceeds a third time threshold value, and wherein the second scheduling information size is associated with one or more combinations of carriers of the first subset of the set of carriers.

8. The UE of claim 1, wherein the second scheduling information size is based at least in part on a first combination of two or more combinations of carriers of the subset of carriers that can be scheduled during the first time period, the first combination associated with a largest payload size of two or more payload sizes associated with the two or more combinations of carriers of the subset of carriers.

9. The UE of claim 8, wherein the second control information includes a table that provides a mapping between a codepoint that is provided in the scheduling information and one or more scheduled carriers of the subset of carriers.

10. The UE of claim 1, wherein the scheduling information does not include frequency domain resource assignment fields when the time duration between receipt of the second control information and the start of the downlink control information monitoring occasion exceeds a time threshold value.

11. The UE of claim 1, wherein the scheduling information includes frequency domain resource assignment fields when the time duration between receipt of the second control information and the start of the downlink control information monitoring occasion is less than a time threshold value, and wherein one or more frequency domain resource assignment fields associated with the first carrier are set to a predetermined value.

12. The UE of claim 1, wherein the time duration between receipt of the second control information and the start of the downlink control information monitoring occasion that indicates the first scheduling information size or the second scheduling information size is based at least in part on a capability reported by the UE or a mode of operation indicated by a network entity.

13. The UE of claim 1, wherein, to monitor, the one or more processors are individually or collectively operable to execute the code to cause the UE to:
attempt to decode the scheduling information from two or more sets of candidate control channel elements, wherein a quantity of sets of candidate control channel elements is based at least in part on the second control information.

14. A method for wireless communications at a user equipment (UE), comprising:
receiving first control information that activates a set of carriers at the UE, and that indicates a scheduling information configuration associated with the set of carriers, wherein the set of carriers includes two or more carriers and the scheduling information configuration indicates a first scheduling information size associated with one or more combinations of carriers of the set of carriers that can be scheduled in a single scheduling information message;
receiving second control information that indicates a first subset of the set of carriers are schedulable for communications during at least a first time period and one or more carriers of the set of carriers will be unscheduled for communications during at least the first time period; and
monitoring for scheduling information in a downlink control information monitoring occasion based at least in part on the first control information and the second control information, wherein the scheduling information has the first scheduling information size or a second scheduling information size based at least in part on a time duration between receipt of the second control information and a start of the downlink control information monitoring occasion, and wherein the second scheduling information size is different than the first scheduling information size.

15. The method of claim 14, wherein the scheduling information in the downlink control information monitoring occasion has the second scheduling information size when the time duration between receipt of the second control information and the start of the downlink control information monitoring occasion exceeds a second time threshold value, and wherein the second scheduling information size is based at least in part on one or more fields associated with the first carrier being omitted from the scheduling information.

16. The method of claim 14, wherein the scheduling information in the downlink control information monitoring occasion has the second scheduling information size when the time duration between receipt of the second control information and the start of the downlink control information monitoring occasion exceeds a third time threshold value, and wherein the second scheduling information size is associated with one or more combinations of carriers of the first subset of the set of carriers.

17. The method of claim 14, wherein the second scheduling information size is based at least in part on a first combination of two or more combinations of carriers of the subset of carriers that can be scheduled during the first time period, the first combination associated with a largest payload size of two or more payload sizes associated with the two or more combinations of carriers of the subset of carriers.

18. The method of claim 17, wherein the second scheduling information size is based at least in part on a first subset of fields associated with the first subset of the set of carriers.

19. The method of claim 18, wherein the second scheduling information size corresponds to a payload size associated with the first combination of the two or more combinations of carriers of the subset of carriers that can be scheduled during the first time period.

20. A non-transitory computer-readable medium storing code for wireless communications, the code comprising instructions executable by one or more processors to:
receive first control information that activates a set of carriers at a user equipment (UE), and that indicates a scheduling information configuration associated with the set of carriers, wherein the set of carriers includes two or more carriers and the scheduling information configuration indicates a first scheduling information size associated with one or more combinations of carriers of the set of carriers that can be scheduled in a single scheduling information message;
receive second control information that indicates a first subset of the set of carriers are schedulable for communications during at least a first time period and one or more carriers of the set of carriers will be unscheduled for communications during at least the first time period; and
monitor for scheduling information in a downlink control information monitoring occasion based at least in part on the first control information and the second control information, wherein the scheduling information has the first scheduling information size or a second scheduling information size based at least in part on a time duration between receipt of the second control information and a start of the downlink control information monitoring occasion, and wherein the second scheduling information size is different than the first scheduling information size.
